(19) United States
(12) Patent Application Publication
(10) Pub. No.: US 2013/0114463 A1
(43) Pub. Date: May 9, 2013

(54) System and Method for Domain Name Resolution for Fast Link Setup

(71) Applicant: FutureWei Technologies, Inc., Plano, TX (US)

(72) Inventor: Zhiming Li, Schaumburg, IL (US)

(73) Assignee: FUTUREWEI TECHNOLOGIES, INC., Plano, TX (US)

(21) Appl. No.: 13/669,001

(22) Filed: Nov. 5, 2012

Related U.S. Application Data
(60) Provisional application No. 61/555,315, filed on Nov. 3, 2011.
(60) Provisional application No. 61/557,052, filed on Nov. 8, 2011.

(51) Int. Cl. H04W 88/10

(52) U.S. Cl. 370/254

(57) ABSTRACT

Performing wireless local area network (W-LAN) access point name (W-APN) resolution concurrently with wireless fidelity (Wi-Fi) link setup reduces latencies involved with accessing a third generation partnership (3GGP) evolved packet core (EPC) network via a Wi-Fi access network. To achieve this, a Wi-Fi access point (AP) sends a W-APN to a domain name system (DNS) server during Wi-Fi link setup, thereby allowing 3GGP gateway assignment to be performed concurrently with Wi-Fi link setup. The W-APN may be a priori information to the mobile station or Wi-Fi AP.

This application claims the benefit of U.S. Provisional Application No. 61/557,052 filed on Nov. 8, 2011, entitled “System and Method for Domain Name Resolution for Fast Link Setup,” and U.S. Provisional Application No. 61/555,312 filed on Nov. 3, 2011, entitled “System and Method for Domain Name Resolution for Fast Link Setup,” both of which are incorporated herein by reference as if reproduced in their entireties.

### TECHNICAL FIELD

The present invention relates to wireless communications, and, in particular embodiments, to systems and methods for domain name resolution for fast link setup.

### BACKGROUND

Mobile stations commonly access third generation partnership (3GGP) evolved packet core (EPC) networks through wireless fidelity (Wi-Fi) access networks. Generally speaking, a mobile station (STA) will build a 3GGP tunnel through the Wi-FI access network in order to access 3GGP EPC services. Conventional techniques for establishing the 3GGP tunnel require the STA to perform wireless local area network (WLAN) Access Point Name (W-APN) resolution after Wi-Fi link setup. W-APN resolution allows one or more enhanced packet data gateways (ePDGs), also known as 3GGP virtual gateways, to be assigned to the STA. Latencies associated with performing W-APN resolution following Wi-Fi link setup may delay construction of the 3GGP tunnel, which adversely affects the quality of service experienced by the user. As such, mechanisms and techniques for reducing and/or avoiding such latencies/delays are desired.

### SUMMARY OF THE INVENTION

Technical advantages are generally achieved, by embodiments of this disclosure which describe systems and methods for domain name resolution for fast link setup.

In accordance with an embodiment, a method for operating an access point (AP) in a wireless fidelity (Wi-Fi) network is provided. In this example, the method includes receiving a Wi-Fi association request from a mobile station, and sending a domain name system (DNS) query to a DNS server. The DNS query specifies a wireless local area network (W-LAN) access point name (W-APN) identifying an interconnection between the Wi-Fi network and a third generation partnership (3GGP) evolved packet core (EPC) network. The method further includes receiving a DNS response from the DNS server that specifies an internet protocol (IP) address of an evolved Packet Data Gateway (ePDG) assigned to the mobile station, and sending a Wi-Fi association response to the mobile station specifying the IP address of the ePDG. An apparatus for performing this method is also provided.

In accordance with another embodiment, a method for operating a mobile station is provided. In this example, the method includes sending a Wi-Fi association request to a wireless fidelity (Wi-Fi) access point (AP) of a Wi-Fi network, and receiving a Wi-Fi association response from the Wi-Fi AP. The Wi-Fi association response includes an internet protocol (IP) address of an ePDG for accessing a third generation partnership (3GGP) evolved packet core (EPC) network. The method further includes obtaining a remote IP address for accessing the 3GGP EPC network from the ePDG. An apparatus for performing this method is also provided.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of a communications network;

FIG. 2 illustrates a protocol diagram of a conventional communications sequence for fast link setup;

FIG. 3 illustrates a protocol diagram of an embodiment communications sequence for fast link setup;

FIG. 4 illustrates a flowchart of an embodiment method for performing fast link setup by a mobile station;

FIG. 5 illustrates a flowchart of an embodiment method for performing fast link setup by a Wi-Fi access point (AP);

FIG. 6 illustrates a flowchart of another embodiment method for performing fast link setup by a Wi-Fi AP;

FIG. 7 illustrates a protocol diagram of a call flow for domain name resolution for link setup;

FIG. 8 illustrates a block diagram of a computing platform; and

FIG. 9 illustrates a block diagram of communications device.

Corresponding numerals and symbols in the different figures generally refer to corresponding parts unless otherwise indicated. The figures are drawn to clearly illustrate the relevant aspects of the presently disclosed embodiments and are not necessarily drawn to scale.

### DETAILED DESCRIPTION OF ILLUSTRATIVE EMBODIMENTS

The making and using of the presently disclosed embodiments are discussed in detail below. It should be appreciated, however, that the present invention provides many applicable concepts that can be embodied in a wide variety of specific contexts. The specific embodiments discussed are merely illustrative of specific ways to make and use aspects of this disclosure, and do not limit the scope of the invention.

During conventional W-APN resolution, an STA sends a W-APN to the 3GGP network (or 3GGP proxy) upon establishing the Wi-Fi link. The W-APN refers to a Fully Qualified Domain Name (FQDN) of the interconnection point between the Wi-Fi access network and the 3GPP EPC network (hereinafter ‘3GGP interconnection point’). Upon receiving the W-APN, the 3GGP network (or proxy) assigns one or more ePDGs (or virtual gateways) to the STA, and thereafter sends IP addresses for the ePDGs to the STA. The STA or Wi-Fi AP selects one of the ePDGs, and proceeds to build a 3GGP tunnel to access the Wi-Fi access network.

In some circumstances, the FQDN/W-APN of the 3GGP interconnection point may be a priori information of the STA or the Wi-Fi access point (AP). For instance, the FQDN/W-APN of the 3GGP interconnection point may have been identified during a prior authentication procedure. This may be the case when the STA is re-authenticating with the Wi-Fi access network after migrating between Wi-Fi APs or after a pairwise transient key (PTK) times out. In such instances, obtaining a 3GGP virtual gateway assignment during Wi-Fi link setup may reduce latencies involved with accessing the 3GGP EPC network.

Aspects of this disclosure provide mechanisms for obtaining a 3GGP virtual gateway assignment during Wi-Fi link setup in order to expedite 3GGP EPC access. More specifically, the Wi-Fi access point (AP) sends a W-APN to a domain name system (DNS) server during Wi-Fi association. In some embodiments, the W-APN is a priori information of the STA that is communicated to the Wi-Fi AP in a Wi-Fi association request. In other embodiments, the W-APN is a priori information of the Wi-Fi AP and is retrieved upon receiving the Wi-Fi association request from the STA. Upon receiving the W-APN, the DNS server assigns one or more ePDGs (e.g., 3GGP WLAN Access Packet Data Gateways) to the STA, and returns a list of IP addresses of the corresponding ePDGs to the Wi-Fi AP. Thereafter, the Wi-Fi AP communicates the list of ePDG IP addresses to the STA via a Wi-Fi association response. Accordingly, the STA is able to proceed directly to 3GGP tunnel setup upon receiving the Wi-Fi association response, thereby circumventing W-APN resolution.

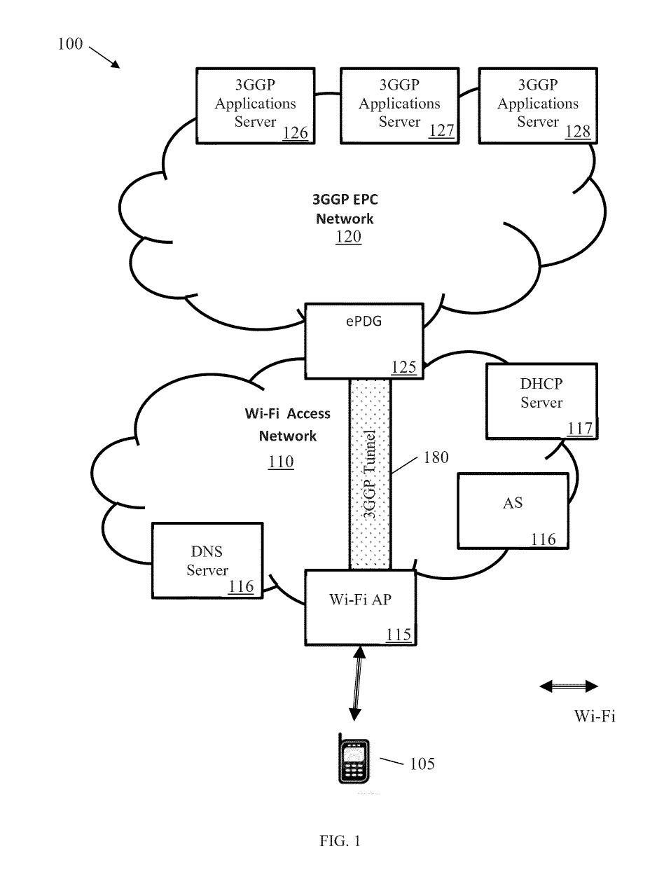

FIG. 1 illustrates a network 100 configured to allow a STA 105 to access a 3GGP EPC network 120 via a Wi-Fi access network 110. As shown, the Wi-Fi access network 110 includes a variety of components, including a Wi-Fi AP 115, an authentication server (AS) 116, a dynamic host configuration protocol (DHCP) server 117, and a domain name system (DNS) server 118. The Wi-Fi AP 115 may be any component configured to provide wireless access to the STA 105. For instance, the Wi-Fi AP 115 and the STA 105 may establish a Wi-Fi link in accordance with the Institute of Electrical and Electronics Engineers (IEEE) standard publication 802.11-2012, which is incorporated herein by reference as if reproduced in its entirety. Establishment of the Wi-Fi link may include an authentication of the STA 105 by the authentication server (AS) 116 as well the assignment of a local Wi-Fi IP address by the DHCP server 117. The AS 116 may be any device configured to evaluate whether the STA 105 should be permitted to access the Wi-FI access network 110 and/or the3GGP EPC network 120, while the DHCP server 117 may be any device configured to acquire configuration information for the STA 105.

In addition to accessing Wi-Fi services, the STA 105 may wish to access 3GGP services provided/hosted by the 3GGP applications servers 126-128. To access these services, the STA may construct/setup a 3GGP tunnel 180 through the Wi-Fi access network 110 to an evolved Packet Data Gateway (ePDG) 125, which may act as a virtual gateway for accessing the 3GGP EPC network 120. Prior to constructing the 3GGP tunnel 180, the ePDG 125 may be assigned to the STA 105 by the DNS server 118. Conventional assignment of the ePDG 125 to the STA 105 occurs via a W-APN resolution procedure following Wi-Fi link setup. However, aspects of this disclosure circumvent W-APN resolution by assigning the ePDG 125 to the STA 105 during Wi-Fi link setup.

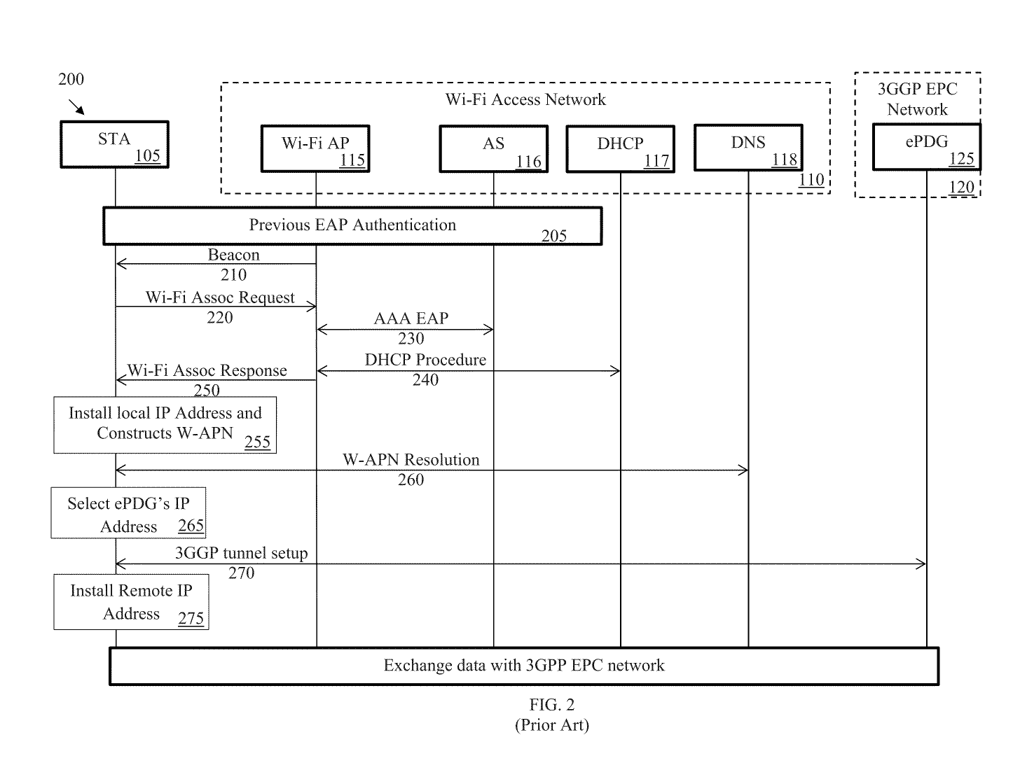

FIG. 2 illustrates a protocol diagram of a conventional communications sequence 200 for accessing a 3GGP network through a Wi-Fi access network, as may occur when a re-authentication is required following a previous EAP authentication 205. The communications sequence 200 begins when the STA 105 detects a beacon 210 from the Wi-FI AP 115. Thereafter, the STA 105 sends a Wi-Fi association request 220 to the Wi-FI AP 115, which prompts the Wi-FI AP 115 to perform an authentication procedure 230 and a DHCP procedure 240. Specifically, the Wi-FI AP 115 performs an authentication procedure 230 with the AS 116 to authenticate the STA 105. Thereafter, the Wi-FI AP 115 performs a DHCP procedure 240 with the DHCP server 117 to procure a local IP address assignment for the STA 105. Subsequently, the Wi-Fi AP 115 sends the local IP address to the STA 105 via the Wi-Fi association response 250.

Upon receiving the Wi-Fi association response 250, the STA 105 installs a local IP address and constructs a W-APN in step 255. The W-APN may be used to identify a specific IP network as well as a point of interconnection to that network (Packet Data Gateway). After constructing the W-APN, the STA 105 performs a W-APN resolution procedure 260 with the DNS server 118. During the W-APN resolution procedure 260, the DNS server 118 assigns the ePDG 125 (and potentially several other 3GGP virtual gateways) to the STA 105, and provides the relevant ePDG IP addresses to the STA 105. The STA 105 selects the IP address corresponding to the ePDG 125 in the step 265, and proceeds to perform a 3GGP tunnel setup procedure 270 with the ePDG 125. The STA 105 is assigned a remote IP address during the 3GGP tunnel setup procedure 270. The STA 105 installs the remote IP address at step 275, and thereafter proceeds to exchange data with the 3GPP EPC network via the 3GPP tunnel.

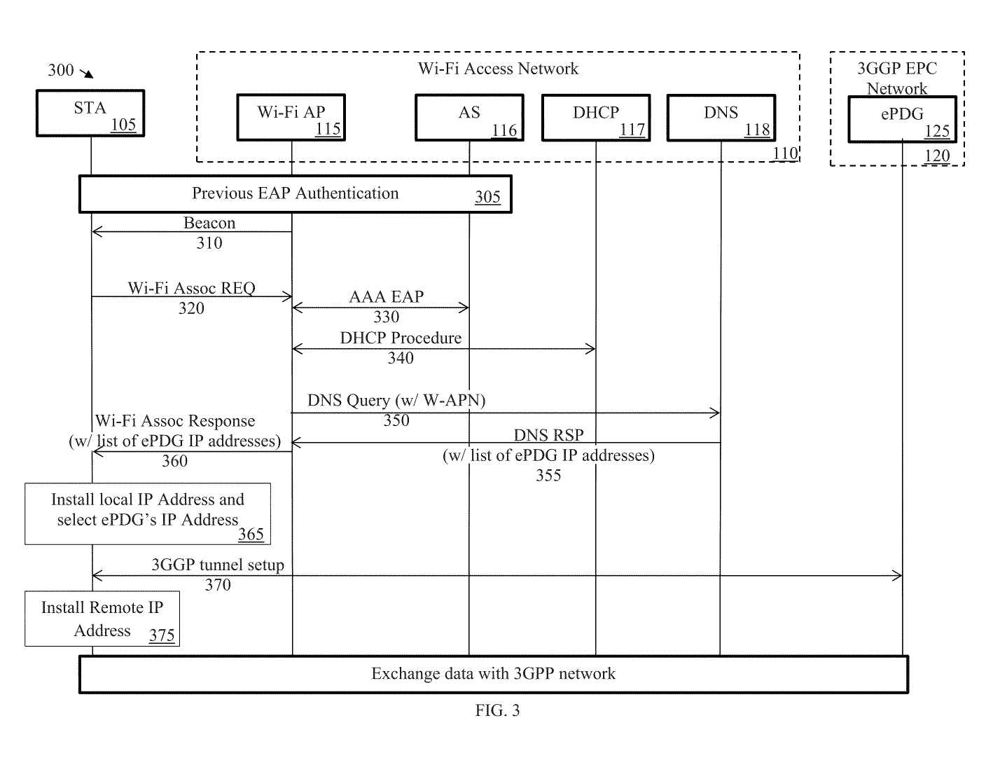

The W-APN resolution procedure 260 may significantly increase the delay/latency associated with establishing a connection with the 3GPP EPC network 120. Aspects of this disclosure provide a mechanism for circumventing W-APN resolution when the W-APN/FQDN of the STA 105 is known by the STA 105 or a Wi-Fi network component (e.g., the Wi-Fi AP 115) during/before Wi-Fi link setup. FIG. 3 illustrates a protocol diagram of an embodiment communications sequence 300 for accessing a 3GGP network through a Wi-Fi access network when the STA's W-APN is a priori information to either the STA 105 or the Wi-Fi AP 115. The communications sequence 300 is triggered when the STA 105 needs to re-authenticate with the Wi-Fi access network 110 following an earlier EAP authentication 305. The circumstances bringing about the need to re-authenticate may vary. For instance, a PTK generated by the STA 105 may have timed out or the STA 105 may have migrated to the Wi-Fi AP 115 from another Wi-Fi AP in the Wi-Fi Access Network 110. In any event, the communications sequence 300 begins when the STA 105 detects a beacon 310. Thereafter, the STA 105 proceeds to send a Wi-Fi association request 320 to the Wi-FI AP 115. In some embodiments, the Wi-Fi association request 320 includes a W-APN, which may be a priori information that the STA 105 learned during an earlier interaction with the 3GGP EPC network 120. In other embodiments, the Wi-Fi association request 320 does not include a W-APN.

Upon receiving the Wi-Fi association request 320, the Wi-FI AP 115 performs an authentication procedure 330 to authenticate the STA 105 and a DHCP procedure 340 to procure assignment of a local IP address to the STA 105. Further, the Wi-FI AP 115 obtains a W-APN of the STA 105. In some embodiments, the W-APN is obtained from the Wi-Fi Association Request message 320. In other embodiments, the W-APN is a priori information of the Wi-Fi AP 115 learned during an earlier interaction with the 3GGP EPC network 120 or pre-configured in the AP which has a service agreement with 3GPP EPC core network. After obtaining the W-APN from the STA 105, the Wi-FI AP 115 sends the W-APN to the DNS server 118 via a DNS query 350. The DNS server 118 resolves the W-APN by assigning a plurality of ePDGs (i.e., 3GGP virtual gateways) to the STA 10. Thereafter, the DNS server 118 communicates a list of ePDG IP addresses to the Wi-Fi AP 115 via the DNS response 355. Upon receiving the DNS response 355, the Wi-Fi AP 115 sends a Wi-Fi association response 360 that includes the list of ePDG IP addresses as well as the local IP address to the STA 105. Thereafter, the STA 105 installs the local IP address and selects an IP address corresponding to the ePDG 125 at step 365, and proceeds to perform a 3GGP tunnel setup procedure 370. The STA 105 is assigned a remote IP address as a result of the 3GGP tunnel setup procedure 370, which the STA 105 installs at step 375. After installing the remote IP address, the STA 105 exchanges data with the 3GPP EPC network via the 3GPP tunnel.

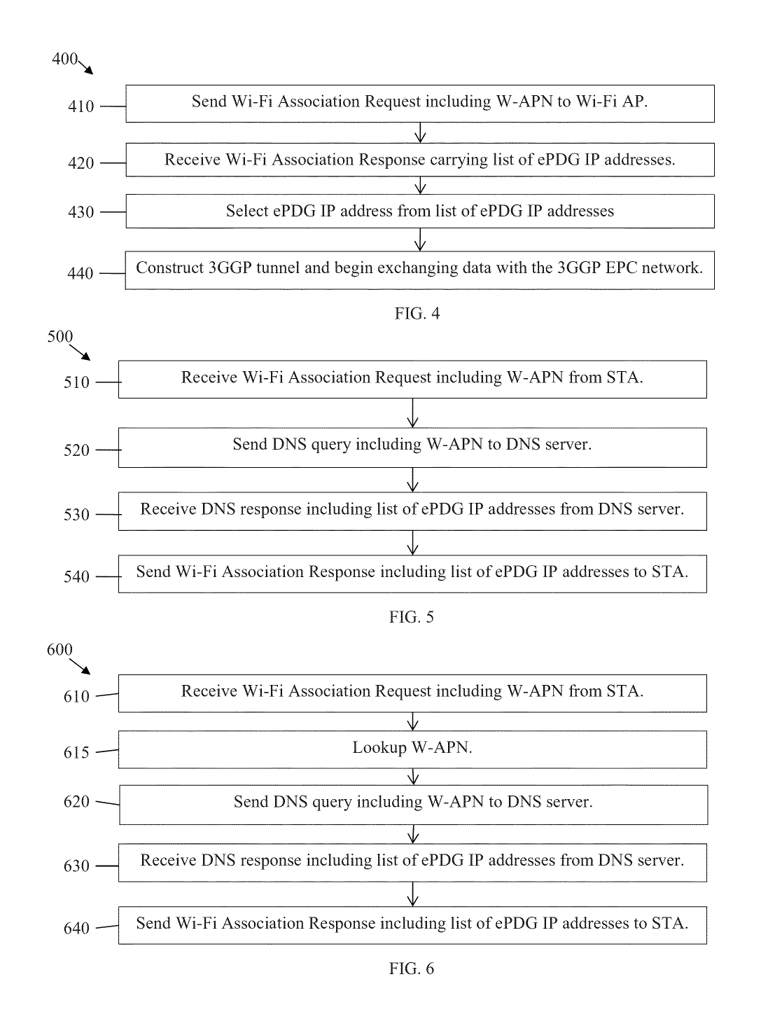

In some embodiments, the W-APN is a priori information to the STA 105. In such embodiments, the STA 105 may communicate the W-APN to the Wi-Fi AP 115 via a Wi-Fi association request message or some other form of signaling. FIG. 4 illustrates a method 400 for obtaining 3GGP virtual gateway assignment during Wi-Fi link setup when the W-APN is a priori information to the STA 105, as might be performed by the STA 105. The method 400 begins at step 410, where the STA 105 sends a Wi-Fi association request including the W-APN to the Wi-Fi AP 115. Next, the method 400 proceeds to the step 420, where the STA 105 receives a Wi-Fi association response carrying a list of ePDG IP addresses from the Wi-Fi AP 115. Thereafter, the method 400 proceeds to the step 430, where the STA 105 selects an ePDG IP address from list of ePDG IP addresses. Thereafter, the method 400 proceeds to the step 440, where the STA 105 constructs the 3GGP tunnel and begins exchanging data with the 3GGP EPC network 120.

FIG. 5 illustrates a method 500 for obtaining 3GGP virtual gateway assignment during Wi-Fi link setup when the W-APN is a priori information to the STA 105, as might be performed by the Wi-Fi AP 115. The method 500 begins at step 510, where Wi-Fi AP 115 receives a Wi-Fi association request including the W-APN from the STA 105. Next, the method 500 proceeds to the step 520, where the Wi-Fi AP 115 sends a DNS query including the W-APN to the DNS server 118. Thereafter, the method 500 proceeds to the step 530, where Wi-Fi AP 115 receives a DNS response carrying a list of ePDG IP addresses from the DNS server 118. Thereafter, the method 500 proceeds to the step 540, where the Wi-Fi AP 115 sends a Wi-Fi association response carrying a list of ePDG IP addresses to the STA 105.

In some embodiments, the W-APN is a priori information to the Wi-Fi AP 115. FIG. 6 illustrates a method 600 for obtaining 3GGP virtual gateway assignment during Wi-Fi link setup when the W-APN is a priori information to the Wi-Fi AP 115, as might be performed by the Wi-Fi AP 115. The method 600 begins at step 610, where Wi-Fi AP 115 receives a Wi-Fi association request from the STA 105. The Wi-Fi association request does not include the W-PAN. Next, the method 600 proceeds to the step 620, where the Wi-Fi AP 115 looks up the W-APN. Thereafter, the method 600 proceeds to the step 630, where the Wi-Fi AP 115 sends a DNS query including the W-APN to the DNS server 118. Thereafter, the method 600 proceeds to the step 640, where Wi-Fi AP 115 receives a DNS response carrying a list of ePDG IP addresses from the DNS server 118. Thereafter, the method 600 proceeds to the step 650, where the Wi-Fi AP 115 sends a Wi-Fi association response carrying a list of ePDG IP addresses to the STA 105.

An embodiment of the invention reduces DNS query/response time. While embodiments of this disclosure are described herein in the context of IP version four (IPv4), said embodiments are equally applicable to IP version six (IPv6). Embodiments may be implemented in various applications such as in mobile terminals and infrastructure equipment in networks, such as IEEE 802.11 compliant devices and networks. For instance, aspects of this disclosure may be utilized by smartphone manufacturers, cellular operators, users of IEEE 802.11 networks, and the like.

In 2011, the 802.11ai group was formed to address a fast initial link setup issue where one goal is to reduce the whole link setup procedure to less than about 100 ms. One proposal suggests combining re-authentication, 802.11 keys setup and IP address assignment together to reduce link setup time. Aspects of this disclosure may be applicable to STAs having a cellular Universal Identity Module (UIM) card with extensible authentication protocol (EAP) Authentication and Key Agreement (EAP-AKA) support. Aspects of this disclosure may be applicable to a cellular subscriber with 802.11ai-capable User Equipment (UE) to access a third party 802.11ai network with an interworking relationship with the cellular operator Aspects of this disclosure may be applicable to EAP Re-Auth Initiate, DHCP Discover with Rapid commit and EAPOL-key message as information elements (IEs) in the Associate Request message. The AP receives the Association Request message, the AP extracts the EAP Re-authentication initiation message, and then performs authentication with a local authentication, authorization, and accounting (AAA) server. The AP extracts the DHCP Discover with Rapid commit message and performs IP address assignment with a DHCP server when the authentication passes. The AP extracts Extensible Authentication Protocol over Local area network (EAPoL) key message and generates 802.11 keys based on the root master session (rMSK) generated from authentication procedure. When authentication is successful, the AP includes EAP re-authentication success message, DHCP message and EAPOL Key message in the Association Response message, and then sends it to the STA. The STA generates 802.11 keys and installs IP address, and then IP traffic flow starts. Because the re-authentication procedure takes about 50 ms, the IP address assignment can be done within 50 ms if the DHCP server is locally configured. The total link setup time is about 50 to 60 ms for access with re-authentication context. In this disclosure, it is assumed that the full authentication procedure is used for the first time.

Another aspect of this disclosure addresses the first access with full authentication use case. This aspect combines IP address assignment and 802.11 keys setup procedure within the full authentication procedure. If a local DHCP server is configured, the whole latency of link setup is almost equal to the timing of full EAP authentication. When EAP-AKA is used in accordance with aspects of this disclosure, the link setup time is about 300 to 500 ms.

In 3GPP and 3GPP2, WLAN interworking with cellular network architecture is defined by 3GPP TS23.234 and 3GPP2 X.S0028, respectively. Once the UE obtains a local IP address, the UE selects or constructs a WLAN Access Point Name (WAPN) in the form of Fully Qualified Domain Name (FQDN) to obtain IP address of Packet Data Gateway (PDG) or Packet Data Interworking Function (PDIF) via Domain Name System (DNS) resolution procedure. The UE sets up an IPSec tunnel with PDG/PDIF, the UE connects to EPC core over this tunnel and gets a remote IP address. Then UE can send/receive IP packets via the cellular core network. In the DNS system, the query/response time is about 15 to 1185 ms. The average time is about 188 ms. The IPSec tunnel setup time is pending on the interaction between PDG/PDIF and AAA Server.

In the smartphone/laptop application case, a user opens a browser and inputs the web address. The smartphone/laptop detects there is a wifi available, connects to the AP, and completes the link setup procedure and 3GPP tunnel setup procedure. The smartphone/laptop retrieves web address's IP address via DNS query/response procedure via 3GPP EPC core network, and then the smartphone/laptop can exchange data with this web address.

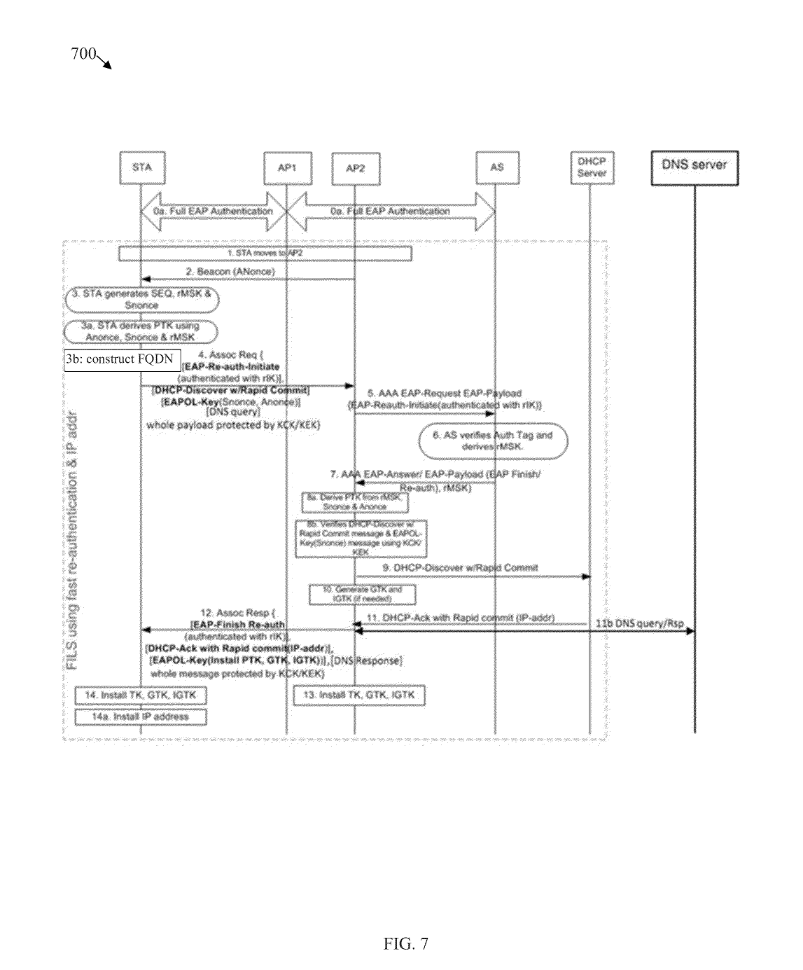

Considering the UE connecting to EPC core network case, techniques for improving DNS procedure during fast initial link setup (FILS) are desired, and in particular during cases where the W-APN are known by the STA or the WiFi AP. An embodiment for domain name resolution for fast link setup includes one or more of the following steps, described with reference to the protocol 700 depicted in FIG. 7. [Step-0] Full authentication may happen using an AP or using a cellular system; [Step 2] AP transmits the Beacon/Probe Resp., which includes 802.11ai capability indicator for ERP & simultaneous IP addr assignment. AP changes Anonce frequently enough; [Step-3] STA generates rMSK before sending Association Request. The rMSK is generated using a procedure defined in Internet Engineering Task Force (IETF) request for comments (RFC) 5296. The rMSK may be generated according to the following formula rMSK=KDF (K, S), where K=rRK, and S=rMSK label |“\0”|SEQ|length; [Step 3b] STA constructs an FQDN using the W-APN Network Identifier and Public Land Mobile Network (PLMN) ID. The PLMN ID is either Visited PLMN ID or Home PLMN ID, and can be determined during network discovery phase. [Step-4] STA packs the following messages as IEs of Association-Request: EAP Re-auth Initiate [Message Integrity using rIK], DHCP Discover with Rapid Commit [Encrypted using KEK], EAPOL-Key (Snonce, Anonce), DNS Query message.

Considering the STA does not get an IP address yet, the source IP address can be 0.0.0.0 for IPv4. It also can be an IPv4 address used before by the STA. The Destination IPv4 address can be 0.0.0.0 or a pre-defined value. The source UDP/TCP port number is selected by the STA per IETF RFC 1035, which is incorporated herein by reference as if reproduced in its entirety. The destination UDP/TCP port number is set to 53 per RFC 1035. The W-APN's FQDN is filled into ‘Question’ part in DNS query message per RFC1035; [Step-4] STA applies message integrity on the combined payload that includes EAP-Re-Auth, DHCP-Discover & EAPOL-Key using KCK; [Step-5] AP holds the DHCP & EAPOL-Key message until it receives rMSK from AS; [Steps 6-7] AS verifies AUTH Tag and derives rMSK, then passes the result to AP2; [Step 8a] AP derives PTK using rMSK, Anonce and Snonce; [Step 8b] AP performs MIC for DHCP & EAPOL Key & DNS Query messages and decrypt DHCP and DNS Query; [Step 9] AP sends DHCP-Discover message with Rapid commit option to DHCP server; [Step 10] AP generates GTK and IGTK, if needed, from PTK; [Step 11] AP get the DHCP-Ack message with Rapid commit option including IP-address assigned to the STA. It is assumed that DNS server address info is also returned in the DHCP-ACK message; Upon receiving the DHCP-Ack message, the AP may replace the Destination IPv4 address with DNS server IP address, and replace the source IPv4 address with either the assigned STA's IPv4 address or the AP's IPv4 address. AP sends DNS query message to DNS server; [Step 11b] AP receives DNS query message from DNS server. The list of the W-APN's IP address is returned in the message. If STA's IPv4 address is the destination IP address, this step 11a can be omitted. If AP's IPv4 address is the destination IP address, AP replaces the destination IPv4 address with assigned STA's IPv4 address; [Step 12] STA packs the following messages as IEs of Association-Response: EAP Finish Re-auth [Message Integrity using rIK], DHCP Ack with Rapid Commit [Encrypted using KEK], EAPOL-Key (Install PTK, GTK, IGTK), DNS response; [Steps 13-14] STA and IP install TK, GTK and IGTK. STA installs IP address. STA obtains the list of W-APN's IP addresses and selects one of the W-APN's IP address. The selected W-APN's IP address is the ePDG's IP address. STA prepares to setup tunnel with PDG/PDIF.

In this embodiment, if STA already has a FQDN of W-APN, step 3b can be skipped. In steps 13-14, STA obtains IP address of the ePDG, builds the 3GPP tunnel with the ePDG, and STA exchanges data with this web address. In FIG. 7, if AP is preconfigured with DNS server address information, then AP can just use AP's IP address and W-APN information provided by STA to communicate with DNS server, and step 11b can be executed along with step 9. When the DNS query message is sent back, the AP can put the IP address of W-APN in the DNS response message and return it to STA along with other EAP/DHCP msg.

In further detail, if AP is pre-configured with DNS server address, and STA does not have DNS server address and gets an assigned IP address, then the STA just fills both DNS server address (DST address) and source IP address (STA's IP address) with 0.0.0.0 or other pre-defined value. STA passes DNS query message along with other EAP/DHCP message to AP. AP decrypts DNS query message, AP gets W-APN information from DNS query message, and AP constructs a new DNS query message or modified received DSN query message. In both cases, DNS server IP address will be Dst IP address, and AP's IP address is Src IP address in the DNS query message. Then AP sends DNS query including W-APN info to DNS server, AP gets DNS Response message back and obtains IP address of W-APN. AP sends DNS response message back to STA along with other EAP/DHCP-ACK message. In DNS response message, Dst IP address can be either STA's assigned IP address (returned by DHCP procedure) or 0.0.0.0 or pre-defined value. Src IP address can be either DNS server address (pre-configured), or 0.0.0.0 or pre-defined value. IP address of WPAN is included in ‘Answer’ field.

For message exchange between STA and AP, the DNS IE can be transported along with EAP/DHCP message instead of DNS query/response message. AP's interaction with DNS server is the same as mentioned above. The only difference is STA uses a new ‘DNS’ IE to provide WAPN info to AP. AP uses ‘DNS’ IE to return IP address of W-APN.

Another embodiment generally differs from the previous embodiment in the following steps: [Step 4] In the Associate-Request message, STA adds a new IE ‘DNS query’. This IE is filled with WAPN's FQDN. This IE is secured along with EAP and DHCP messages.

[Step 8b] AP decrypts ‘DNS query’ IE; [Step 11a] AP constructs DNS query message using WAPN's info, DNS server info; [Step 11b] DNS server returns the list of W-APN's IP addresses, AP obtains the list WAPN's IP address via DNS response message; [Step 12] AP adds a new IE ‘DNS’ query in the Associate Response message. The value of ‘DNS’ IE is set to the list of WAPN's IP address. This IE is secured along with EAP and DHCP messages; [Steps 13-14] are similar to steps 13-14 in the previous embodiment.

In this embodiment, if STA already has a FQDN of W-APN, step 3b can be skipped. In steps 13-14, STA obtains IP address of ePDG, and STA exchanges data with this web address. This embodiment also applies to WAPN's info during the first time full-authentication procedure. An embodiment method includes the STA providing WAPN's FQDN info as a new IE to AP. The AP constructs DNS query msg using WAPN's FQDN info and DNS server info obtained during IP address assignment exchange between AP and DHCP server. The AP obtains the list of WAPN's IP address in the DNS response message from DNS server. The AP passes the list of WAPN's IP address to STA. After these steps, STA set up IP tunnel with PDG/PDIF as specified in 3GPP/3GPP2.

The embodiments described above use the associate request/associate response messages as one example for conveying the DNS query/response messages or new IE. Additionally or alternatively, other messages can be used to transport the DNS query/response or new IE. For example, the authentication message can be used by either the STA or AP, or the re-association request/response message pair can be used. As another example, a newly-defined message can be used between the STA and the AP. If the authentication message is used, the STA sends an authentication message including the DNS query/response message or new IE to the AP, and the AP performs the same procedure as described above. Then the AP sends the authentication message including the DNS response message or new IE to the STA. If the re-association request/response message pair is used, the STA sends the re-association request message including the DNS query/response message or new IE to the AP, and the AP performs the same procedure described above. Then the AP sends the re-association response message including the DNS response message or new IE to the STA.

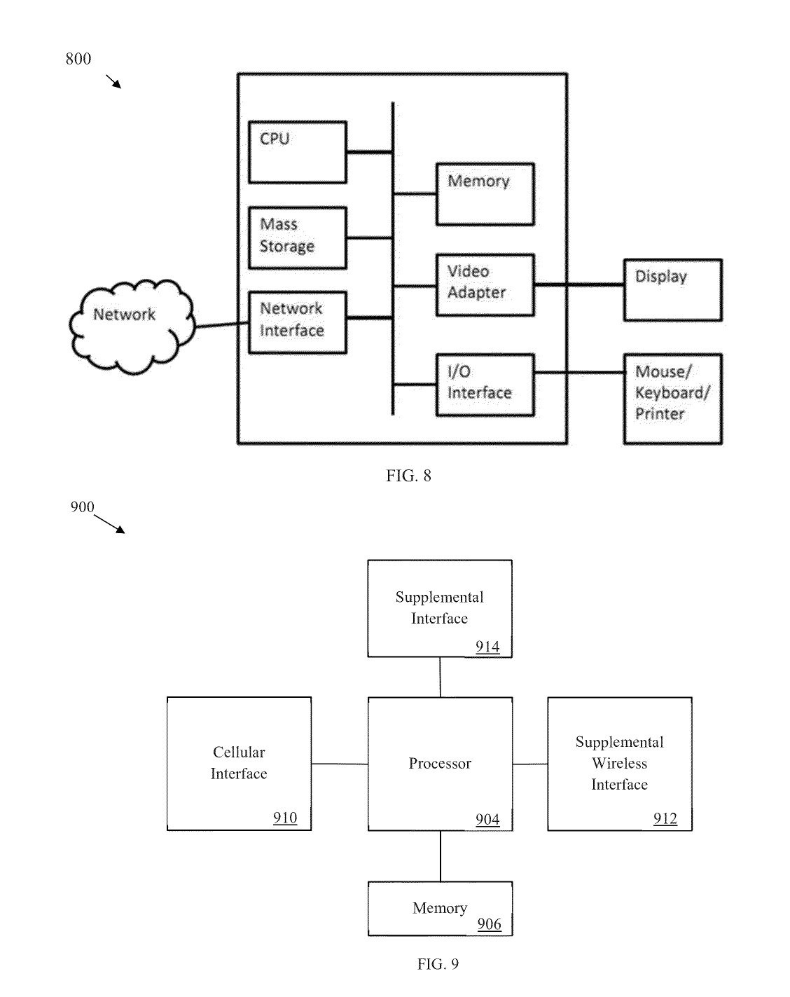

FIG. 8 is a block diagram of a processing system 800 that may be used for implementing aspects of this disclosure. Specific devices may utilize all of the components shown, or only a subset of the components shown, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

The following references are related to subject matter of the present application. Each of these references is incorporated herein by reference in its entirety: IETF RFC 5295 Specification for the Derivation of Root Keys from an Extended Master Session Key (EMSK); IETF RFC 5296 EAP Extensions for EAP Re-authentication Protocol (ERP); 3GPP TS 23.234: “3GPP system to Wireless Local Area Network (WLAN) interworking; System Description”; 3GPP2 X.S0028: “cdma2000 Packet Data Service: Wireless Local Area Network (WLAN) Interworking”; RFC 1035, Domain Names - Implementation and Specification; A. Mishra, M. Shin, and W. Arbaugh. “An empirical analysis of the IEEE802.11 MAC layer handoff process” SIGCOMM comput, commun. Rev. 33(2):93-102, 2003; IEEE 21-07-0401-00-0000 “Performance analysis of authentication signaling schemes for media independent handovers”; IEEE 802.11-11-1160r2 ‘Fast authentication in TGai′; IEEE 802.11-11-1047r3 Using upper layer message IE in TGai′; http://www.ghacks.net/2011/01/20/dns-performance-test/.

FIG. 9 illustrates a block diagram of an embodiment of a communications device 1000, which may be equivalent to one or more devices (e.g., UEs, NBs, etc.) discussed above. The communications device 900 may include a processor 904, a memory 906, a cellular interface 910, a supplemental wireless interface 912, and a supplemental interface 914, which may (or may not) be arranged as shown in FIG. 9. The processor 904 may be any component capable of performing computations and/or other processing related tasks, and the memory 906 may be any component capable of storing programming and/or instructions for the processor 904. The cellular interface 910 may be any component or collection of components that allows the communications device 900 to communicate using a cellular signal, and may be used to receive and/or transmit information over a cellular connection of a cellular network. The supplemental wireless interface 912 may be any component or collection of components that allows the communications device 900 to communicate via a non-cellular wireless protocol, such as a Wi-Fi or Bluetooth protocol, or a control protocol. The device 900 may use the cellular interface 910 and/or the supplemental wireless interface 912 to communicate with any wirelessly enabled component, e.g., a base station, relay, mobile device, etc. The supplemental interface 914 may be any component or collection of components that allows the communications device 900 to communicate via a supplemental protocol, including wire-line protocols. In embodiments, the supplemental interface 914 may allow the device 900 to communicate with another component, such as a backhaul network component.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for operating an access point (AP) in a wireless fidelity (Wi-Fi) network, the method comprising:
receiving, by the AP, a Wi-Fi association request from a mobile station;
sending, by the AP, a domain name system (DNS) query to a DNS server, wherein the DNS query specifies a wireless local area network (W-LAN) access point name (W-APN) identifying an interconnection between the Wi-Fi network and a third generation partnership (3GGP) evolved packet core (EPC) network;
receiving, by the AP, a DNS response from the DNS server, the DNS response specifying an internet protocol (IP) address of an evolved Packet Data Gateway (ePDG) assigned to the mobile station; and
sending, by the AP, a Wi-Fi association response to the mobile station, wherein the Wi-Fi association response specifies the IP address of the ePDG.

2. The method of claim 1, wherein the ePDG is assigned to the mobile station prior to completing a Wi-Fi link setup procedure initiated by the Wi-Fi association request.

3. The method of claim 1, wherein the ePDG is assigned to the mobile station before the mobile station installs a local IP address for accessing the Wi-Fi network.

4. The method of claim 1, wherein the W-APN is communicated in the Wi-Fi association request.

5. The method of claim 1, wherein the W-APN is a priori information to the AP.

6. The method of claim 1, wherein the DNS response contains a list of addresses for a set of ePDGs assigned to the mobile station, and wherein the ePDG is selected from the set of ePDGs by the mobile station or by the AP.

7. A wireless fidelity (Wi-Fi) access point (AP) of a Wi-Fi network, the Wi-Fi AP comprising:
a processor; and
a computer readable storage medium storing programming for execution by the processor, the programming including instructions to:
receive a Wi-Fi association request from a mobile station;
send a domain name system (DNS) query to a DNS server, wherein the DNS query specifies a wireless local area network (W-LAN) access point name (W-APN) identifying an interconnection between the Wi-Fi network and a third generation partnership (3GGP) evolved packet core (EPC) network;
receive a DNS response from the DNS server, the DNS response specifying an internet protocol (IP) address of an evolved Packet Data Gateway (ePDG) assigned to the mobile station; and
send a Wi-Fi association response to the mobile station, wherein the Wi-Fi association response specifies the IP address of the ePDG.

8. The Wi-Fi AP of claim 7, wherein the ePDG is assigned to the mobile station prior to completing a Wi-Fi link setup procedure initiated by the Wi-Fi association request.

9. The Wi-Fi AP of claim 7, wherein the ePDG is assigned to the mobile station before the mobile station installs a local IP address for accessing the Wi-Fi network.

10. The Wi-Fi AP of claim 7, wherein the W-APN is communicated in the Wi-Fi association request.

11. The Wi-Fi AP of claim 7, wherein the W-APN is a priori information to the AP.

12. A method for operating a mobile station, the method comprising:
sending, by the mobile station, a Wi-Fi association request to a wireless fidelity (Wi-Fi) access point (AP) of a Wi-Fi network;
receiving, by the mobile station, a Wi-Fi association response from the Wi-Fi AP, the Wi-Fi association response including an internet protocol (IP) address of an evolved Packet Data Gateway (ePDG) for accessing a third generation partnership (3GGP) evolved packet core (EPC) network; and
obtaining, by the mobile station, a remote IP address for accessing the 3GGP EPC network from the ePDG.

13. The method of claim 12, wherein the remote IP address is obtained without performing a wireless local area network (WLAN) Access Point Name (W-APN) resolution.

14. The method of claim 12 further, wherein the Wi-Fi association response further comprises a local IP address for accessing the Wi-Fi network, and wherein the method further comprises:
installing the local IP address after receiving the Wi-Fi association response; and
installing the remote IP address without performing a W-APN resolution.

15. The method of claim 14, wherein the ePDG is assigned to the mobile station before the mobile station installs the local IP address for accessing the Wi-Fi network.

16. The method of claim 12, wherein the W-APN is communicated in the Wi-Fi association request.

17. The method of claim 12, wherein the W-APN is a priori information of the Wi-Fi AP.

18. A mobile station comprising:
a processor; and
a computer readable storage medium storing programming for execution by the processor, the programming including instructions to:
send a Wi-Fi association request to a wireless fidelity (Wi-Fi) access point (AP) of a Wi-Fi network;
receive a Wi-Fi association response from the Wi-Fi AP, the Wi-Fi association response including an internet protocol (IP) address of an evolved Packet Data Gateway (ePDG) for accessing a third generation partnership (3GGP) evolved packet core (EPC) network; and
obtain a remote IP address for accessing the 3GGP EPC network from the ePDG.

19. The mobile station of claim 18, wherein the remote IP address is obtained without performing a wireless local area network (WLAN) Access Point Name (W-APN) resolution.

20. The mobile station of claim 18, wherein the W-APN is communicated in the Wi-Fi association request.

21. The mobile station of claim 18, wherein the W-APN is a priori information of the Wi-Fi AP.
